(19) United States
(12) Patent Application Publication
(10) Pub. No.: US 2007/0192311 A1
(43) Pub. Date: Aug. 16, 2007

(54) Method And System Of Identifying An Ideographic Character

(76) Inventors: Samuel Yin Lun Pun, Calgary (CA); Weigen Qiu, Calgary (CA); Lin Zhang, Calgary (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/673,785

(22) Filed: Feb. 12, 2007

Related U.S. Application Data
(60) Provisional application No. 60/772,410, filed on Feb. 10, 2006.

(51) Int. Cl. G06F 17/30; G06F 17/21; G06F 17/00

(52) U.S. Cl. 707/5; 715/535; 707/3; 704/10

(57) ABSTRACT

A method and a system for identifying an ideographic character is disclosed. A keypad is used to identify two parts of a linguistic character. A microprocessor queries a database for characters corresponding to the identified parts, and then displays the associated characters on a monitor for selection by a user.

### CROSS-REFERENCE TO RELATED APPLICATION

This application claims the benefit of priority to U.S. provisional patent application Ser. No. 60/772,410, filed on Feb. 10, 2006.

### FIELD OF THE INVENTION

The present invention relates to methods and systems that assist a person with entering ideographic characters.

### BACKGROUND OF THE INVENTION

The prior art includes methods and devices that assist a person with entering text. For example, when a person desires to enter text on a cellular telephone, the person may be required to use a keypad having keys that have more than one character assigned to a key. For example, in a common type of such a limited keypad, one of the keys may be used to indicate the characters “2”, “a”, “b” or “c” and another key may be used to indicate the characters “5”, “j”, “k”, “l”. As the user presses keys, software may be used to determine which of the possible characters the user intends to enter with a particular keypress.

When a limited keypad is used to identify ideographic characters, stroke categories may be used by the software to aid in determining what the user intends by one or more keypresses. The use of stroke categories often involves grouping strokes by the shape of a stroke and/or the direction in which a person usually writes the stroke with a pen. The number of stroke categories is usually limited to a small number that can be allocated to some or all of the keys of the keypad. When a person presses a key, a software implemented disambiguator interprets the keypress to mean one of the strokes assigned to that category. The order of the keypresses may be used to identify candidate ideographic characters that have the same stroke order. The candidate ideographic characters may be displayed in an ordered fashion. The user then selects the desired ideographic character.

In another method, alphabetic or syllabic elements are used to phonetically spell the sound that is made when pronouncing an ideographic character. As the alphabetic or syllabic elements are entered, candidate characters which are homophones are displayed in an ordered fashion, and the user may select from the displayed characters in order to identify an ideographic character that the user desires to enter. In one such method, commonly referred to as “pinyin”, Chinese ideographic characters may be identified by using the Latin alphabet to phonetically spell the sound made when pronouncing a Chinese ideographic character.

A disadvantage of this pinyin method is that it is rather slow. A number of letters usually must be entered before an ideographic character is identified. In some cases, software may be able to predict only the last one or two pinyin characters, and so this prediction capability is not much help to the user.

As a practical matter, pinyin characters can be divided into either one or two parts (sometimes referred to herein as “elements”). For example, the character “ping” can be constructed by entering a stem-part “p” and an end-part “ing”. The use of stem-parts and end-parts is known in the art.

In lieu of allocating characters to a key on the keypad, a method commonly referred to as “Shuangpin” allocates letter combinations to the keys of a full, conventional keypad having the usual qwerty layout. FIG. 1 shows how letter combinations may be allocated to the keys of such a keypad.

In the case where a pinyin character has only one part, that pinyin character can be identified by entering a “blank” symbol followed by the pinyin character. Typically, the “blank” symbol is identified by pressing the key for an apostrophe, although any non-letter symbol can be used. In these situations, one of the parts may be thought of as constituting “silence” or as sometimes noted herein, the sound of silence.

In a method using Shuangpin, the pinyin candidate may be displayed once the parts are identified by a user. However, once the parts are identified, the pinyin candidate need not be displayed, and instead, the candidate ideographic characters may be displayed directly for selection. Selection of a candidate character may be accomplished by moving a cursor until the desired ideographic character is highlighted, or by using a stylus on a touch-sensitive monitor.

An earlier Chinese patent (#99120322.4) granted to Nokia maps a full-size keypad layout onto the reduced numeric keypad in a fashion similar to the way that individual letters are grouped and allocated for the alphabet, but these stem-parts and end-parts are accessed by striking the keys until the part is selected. For example, to select the pinyin element made up of keys where the Shuangpin elements are listed second on each key, the key bearing the initial element is pressed twice in rapid succession and then the key bearing the final element is pressed twice in rapid succession. Such a method is commonly referred to as “multi-tap”. In the event that the same key bears both elements, a pause is mandatory between the double press events to preclude rapid stepping to the wrong element. This technique of multi-tapping is well known in the art and is the primary method for text entry for short message exchange today.

### SUMMARY OF THE INVENTION

The invention may be embodied as a method of identifying an ideographic character. In one such method, a keypad is provided. The keypad may have a plurality of keys, at least one of the keys representing more than one sound. A database may be provided. The database may have characters, each of which is associated with one or more names. Each of the names may correspond to exactly two keypresses. Sounds, comprising a first sound set, may be assigned to each of the keys. For example, portions of pinyin characters may be used to represent the sounds. Some of the sounds in the first sound set may be those made when pronouncing a portion of a linguistic character, such as a pinyin character, and one of the sounds may be the sound of silence.

One of the keys may be pressed. The pressed key may correspond to a desired first sound from the first sound set. The key press may both (A) provide a first keypress to a microprocessor, and (B) initiate a reassigning of sounds to each of the keys, the newly assigned sounds may comprise a second sound set that is different from the first sound set. Some of the sounds in the second sound set may be those made when pronouncing a portion of a linguistic character, and one of the sounds may be the sound of silence.

Then, one of the keys corresponding to a desired second sound from the second sound set may be pressed to provide a second keypress to the microprocessor. From the keypresses, one or more ideographic characters corresponding to both the first and second keypresses may be identified and provided to a user, who may then select a desired ideographic character from those that are provided.

In one embodiment of the invention, at least some of the characters in the database are pinyin characters, and prior to identifying one or more ideographic characters, pinyin characters from the database are provided to a user so that the user can select one of the pinyin characters. The pinyin characters may be provided to the user by displaying on a monitor one or more characters phonetically representing the sounds identified by both of the keypresses. In such an embodiment, the act of identifying one or more ideographic characters includes an intermediate step of selecting one of the pinyin characters.

The pinyin characters may be provided to the user in an order representative of when each pinyin character was last selected. For example, the most recently selected pinyin characters may be provided toward the top of a list. In this fashion, a user may be able to more easily identify and select a desired pinyin character from the list.

Another tactic may include predicting a pinyin character based on the pinyin characters that preceded. The predicted pinyin characters may be provided near the top of a list that is presented to the user. In this fashion, a user may be able to more easily identify and select a desired next pinyin character from the list.

The invention may be embodied as a system for identifying an ideographic character. The system may include a keypad having a plurality of keys. At least one of the keys may be made to represent more than one sound. By pressing such a key, more than one sound may be indicated by the user.

A system according to the invention may include a database of characters. The database will include ideographic characters, and may also include pinyin characters. Every character in the database may be associated with one or more names, each name corresponding to exactly two keypresses. In this fashion, by providing two keypresses, a user may identify a name that corresponds to one or more ideographic characters. In one embodiment of the invention, the names are associated with pinyin characters, and the ideographic characters are associated with the pinyin characters.

The system may also include a microprocessor that is in communication with the keypad and the database. The microprocessor may be programmed to carry out a method, such as the method described above.

### BRIEF DESCRIPTION OF THE DRAWINGS

For a fuller understanding of the nature and objects of the invention, reference should be made to the accompanying drawings and the subsequent description. Briefly, the drawings are:

FIG. 1 depicts an assignment of sounds to keys according to the Shuangpin method;

FIG. 2 depicts a method according to the invention;

FIG. 3 depicts a system according to the invention; and

FIG. 4 depicts an assignment of sounds to keys that may be used in a method or system according to the invention.

### FURTHER DESCRIPTION OF THE INVENTION

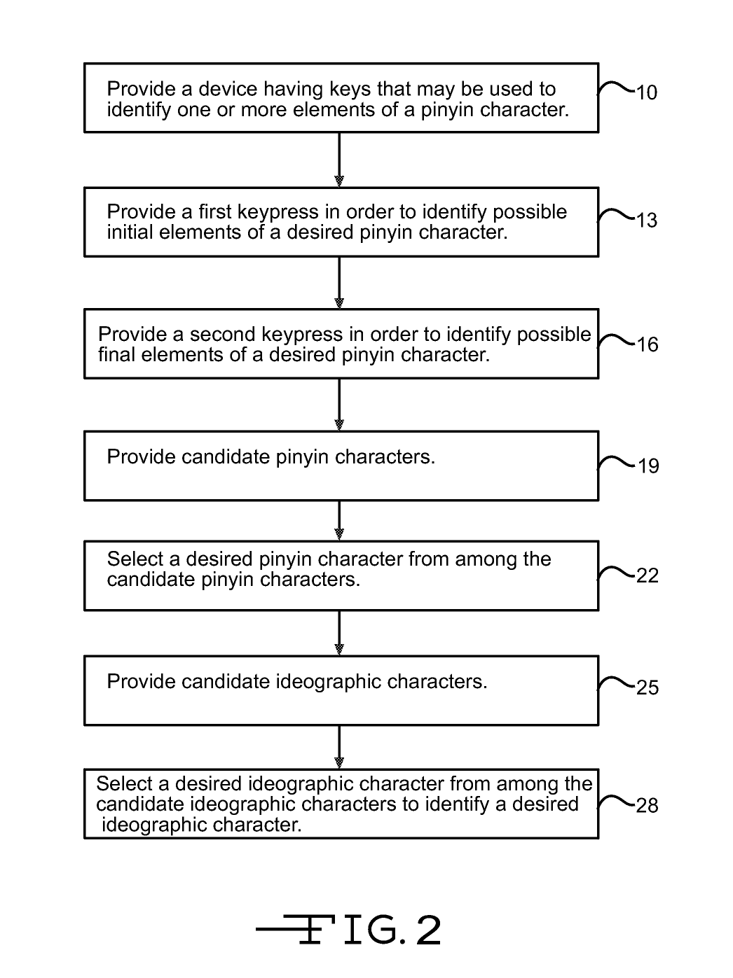

The present invention includes a method of identifying ideographic characters. FIG. 2 depicts one such method. In that method, a device is provided 10, and the device includes keys, each of which may be used to identify one or more elements of a pinyin character that is desired by a user. By providing 13 a first keypress, a user may identify possible initial elements of the desired pinyin character. By providing 16 a second keypress, the user may identify possible subsequent elements of the desired pinyin character. Having identified possible initial and subsequent elements, candidate pinyin characters may be provided 19 in a list that the user may select from. The candidate pinyin characters may be those pinyin characters that have an initial element corresponding to the first keypress and a subsequent element corresponding to the second keypress. In this fashion, the user is required to make only two keypresses in order to be presented with a list of candidate pinyin characters.

Using the list of candidate pinyin characters, the user may select 22 a desired pinyin character. In response, a list of candidate ideographic characters may be provided 25. The candidate ideographic characters may be those that sound like the desired pinyin character. The user may select 28 from the candidate ideographic characters in order to identify a desired ideographic character.

A list of candidate pinyin characters can be generated by combining any one of the possible initial elements with any one of the possible subsequent elements. Suitably designed software may assemble the candidate pinyin characters for display (i.e. provided 19) in an ordered fashion so that a user might more easily select the desired pinyin character. Of course, certain combinations of elements might be impermissible since there may not be a pinyin character for every possible combination of the elements. The software may eliminate combinations of elements that are impermissible and may offer suggestions as to workable alternates to the user.

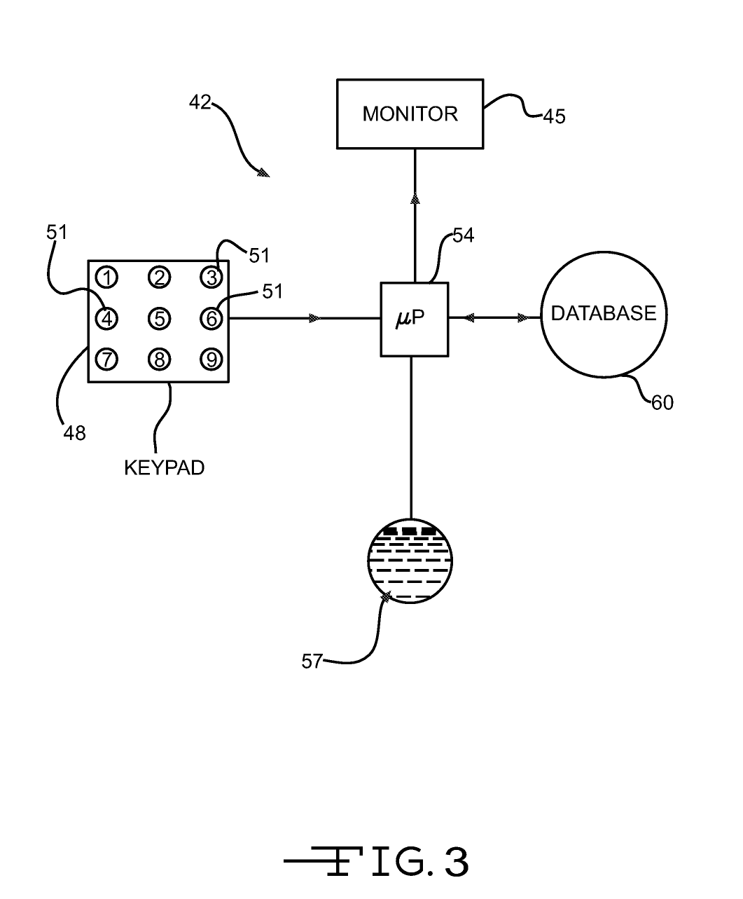

The invention may be embodied as a system 10 that carries out the method. One such system 42 is shown schematically in FIG. 3. Such a system 42 may have a monitor 45 and a key pad 48 having a plurality of keys 51. The keys 51 are shown in FIG. 3 with the numbers 1 through 9, for ease of reference. It should be noted that the keys 51 may have letters on them. For example, the key 51 identified by the number “2” in FIG. 3 may actually be used to indicate the symbols “2”, “a”, “b” or “c” and may have these symbols printed on the key 51. Similarly, the key 51 identified by the number “6” in FIG. 3 may actually be used to indicate the symbols “6”, “m”, “n” and “o” and may have these symbols printed on the key 51.

The system 42 may also have a microprocessor 54 for carrying out instructions 57 provided by a software program. The instructions 57 may be directed at causing the system 42 to execute the method described above. Using such a system 42, a user may press a key 51 to provide a “keypress” to the microprocessor 54. The monitor 45 may be used to display candidate pinyin characters, and later the candidate ideographic characters, to the user. When a system 42 according to the invention is ready to accept an initial element of a pinyin character, the user may press one of the keys 51 in order to indicate the user's desire to identify an initial sound element corresponding to that key 51. One initial element or more than one initial element may correspond with any particular key 51. Once a key 51 has been pressed to identify an initial sound element, the system 42 may ready itself to accept a subsequent element of the pinyin character.

Once ready to accept a subsequent element, the user may press one of the keys 51 in order to indicate the user's desire to identify the subsequent element of the pinyin character. One subsequent element or more than one subsequent element may correspond with any particular key 51. Further, a key 51 used to indicate an initial element may also be used to indicate a subsequent element.

Having indicated the initial and subsequent elements, the system 42 may provide a list of pinyin characters for which the initial and subsequent elements match those indicated by the keypresses. For example, the system 42 may use the monitor 45 for displaying the pinyin characters. The user may select from the list of candidate pinyin characters in order to identify a desired pinyin character, and the system 42 may then display a list of candidate ideographic characters corresponding to the selected/desired pinyin character. The user may then select from the list of candidate ideographic characters in order to identify a desired ideographic character.

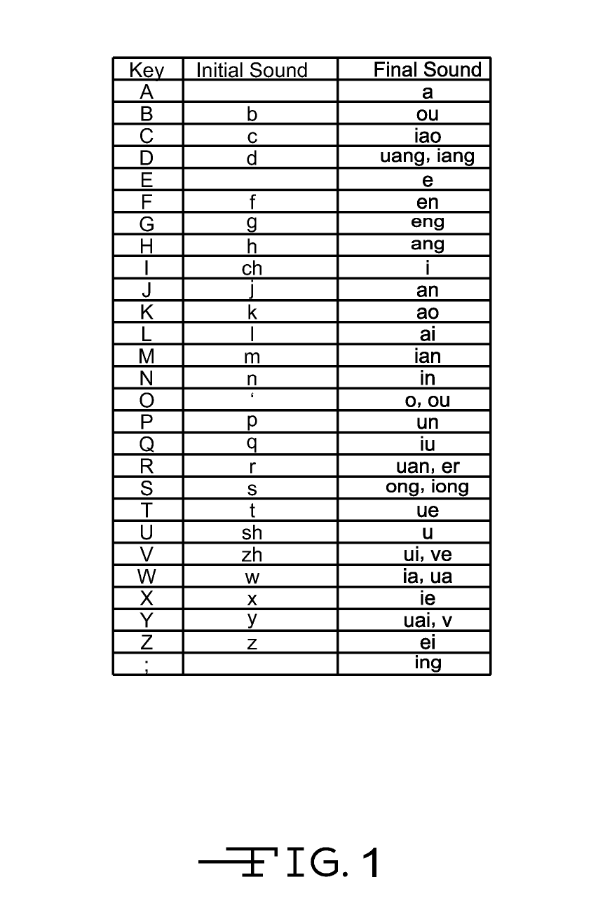

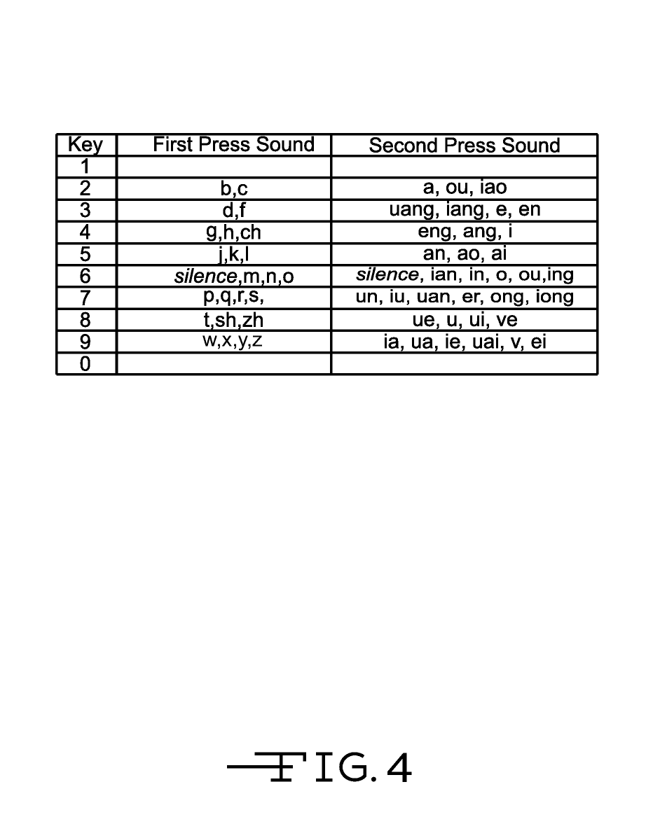

By careful arrangement of initial and subsequent elements to the key 51s of a keypad 48, candidate lists might be more easily provided to the user. FIG. 4 shows one such arrangement where the keys 51 have the usual correspondence shown in FIG. 1 except that the final sound “ing” may be assigned to the 6mno key 51. As a memory aid, it is permissible to mark the key 51 with an ancilliary marking so as to remind the user that the key 51 serves more than its normal function. In FIG. 4, each key 51 corresponds to both an initial element and at least one subsequent element. On the first press, the key 51 will indicate a first sound and on the next press it will indicate a subsequent sound. For example, the key 51 having the letter “b” corresponds to the initial element “b” or “c” and also to the subsequent element “a”, “iao” or “ou”. When a system 42 according to the invention is ready to accept an initial element, pressing the 2abc key 51 will result in indicating that “b” or “c” is the initial element of the desired pinyin character. However, when the system 42 is ready to accept a subsequent element, pressing the 2abc key 51 a second time will result in indicating that ba, biao, ca and cou as the suggested pinyin character candidates. Since bou and ciao are not pinyin characters, they need not be provided to the user for selection.

Using the arrangement of FIG. 4, the system 42 and method may be further illustrated by considering an extension to the above example. If the system 42 is ready to accept an indication of an initial element following the two presses of the 2abc key 51 above, and the user presses the 2abc key 51 again, the system 42 will interpret this to mean that the user desires to identify the initial element of the next pinyin character. So in this example, the entry of three consecutive presses would correspond to the first pinyin term followed by the indication for a space then the first element of the next pinyin term. In this case a user might see only the three possibilities “ba'b”, “biao'b” and “biao'c” (where the apostrophe is used to indicate a space element here). Having received the user's identification of the initial element of the second pinyin term, the system 42 will then ready itself to receive an indication of the subsequent element of the desired pinyin character. If the user then presses the 2abc key 51 yet again (a fourth time), the system 42 will interpret this to mean that the user desires to identify either “a”, “ou” or “iao” as the subsequent element of the desired pinyin character. The system 42 will then locate pinyin characters having only valid spelling and will display to the user “ba'ba”. Once such pinyin characters are located, the system 42 may display the located pinyin characters as a list of candidate pinyin characters. The user may then select from the list to identify a desired pinyin character, and the system 42 will respond by locating ideographic characters that are associated with the desired pinyin character. Once such ideographic characters are located, the system 42 will display the located ideographic characters as a list of candidate ideographic characters, and the user may select a desired ideographic character from that list. In some circumstances where the choices are few, the system 42 may show the ideographic representation at the earliest possible time so that a user may improve the rate of entry by having fewer steps to make to select an intended character.

Although the invention has been described with reference to Chinese ideographic characters, it will be recognized that the invention may be used with many types of ideographic character systems, including those associated with Japanese. In a Japanese text entry method according to the invention, a more appropriate symbology might be one or both of the Kana sets.

Although the multi-tap method has certain instances where it happens that the initial and final elements are in first place on a key and so would only require a single keypress for each element, many acceptable combinations would not be identifiable by merely two keypresses. It is important to note that the instant invention may be implemented so that the user is required to enter exactly one keypress for each element in a two element method such as Shuangpin. The reduction of the variable number of keypresses to a consistent two press method represents an improvement in the state of the art and maximizes user benefit.

The system 42 will now be described in more detail The system 42 shown in FIG. 3 has a keypad 48, a database 60 of characters, and a microprocessor 54. The microprocessor 54 may be able to communicate with the keypad 48 so as to receive keypresses from the keypad 48. Further, the microprocessor 54 may be able to communicate with the database 60 so as to locate characters corresponding to keypresses.

The keypad 48 may have a plurality of keys 51, at least one of which may be made to represent more than one sound. For example, one of the keys 51 may be made to represent the sounds “b”, “c”, “a”, “ou” and “iao” so that by pressing that key 51, these sounds will be indicated to the microprocessor 54, except that they may be limited by context so that if the key 51 is used in the context of being an initial element, the sounds related to a final element will not be considered and vice versa. As such, the user would not be able to definitively identify which of the sounds is desired by the user. Instead, the user would be able to identify several sounds—one of which is desired by the user.

The database 60 of characters may be structured so as to associate names with each character in the database 60, and each name may consist of exactly two keypresses. For example, the character “de” (possessive indicator used in “wo-de”, which is translated in the English language as “mine”) may be associated with the name “23”—so called because the “2” and the “3” key 51 are pressed in succession in order to signify the name “23”. As such, when a user presses the “2” key 51 followed by the “3” key 51, the name “23” would be indicated, and the microprocessor 54 would then retrieve characters from the database 60 associated with the “23” name. It should be noted that more than one character may have the same name, and so when the keypresses identify a particular name, the microprocessor 54 may return more than one character.

The microprocessor 54 may be able to receive keypresses from the keypad 48 and may be able to query the database 60 for characters. Furthermore, the microprocessor 54 may be programmed to assign and reassign sounds to each of the keys 51. In this manner, when a particular keypress is provided from the keypad 48, the microprocessor 54 will interpret this as identifying one or more particular sounds assigned to that key 51.

Initially, the sounds assigned to the keys 51 may be drawn from a first sound set. For example, a first sound set may be those identified as “Initial Sound” in FIG. 4. So, for example, when the first sound set is the “Initial Sound” set of FIG. 4, the user may identify the “zh” sound by pressing the 8tuv key 51, or may identify the “x” sound by pressing the 9wxyz key 51. In this manner, the user may provide an indication to the microprocessor 54 that at least one of the sounds from the first sound set is desired.

In response to the first keypress indicating a sound from the first sound set, the microprocessor 54 may both (i) receive the first keypress, and (ii) initiate a reassigning of sounds to one or more of the keys 51. In reassigning sounds to the keys 51, the newly assigned sounds may be drawn from a second sound set that is different from the first sound set. For example, the second sound set may be the “subsequent sound” set of FIG. 4. In this manner, the same keys 51 may be used to identify different sounds. Once reassignment has occurred, the user may provide a second keypress in order to provide an indication of a desired sound from the second sound set. The desired sound may be among many that are assigned to the pressed key 51, and so the second keypress may not definitively identify which sound is desired by the user.

The microprocessor 54 may then receive the second keypress corresponding to a desired second sound. The microprocessor 54 may then query the database 60 using the name identified by the first and second keypresses. One or more ideographic characters corresponding to both the first and second keypress may be identified by the microprocessor 54. The identified ideographic characters may be provided to the user for selection. For example, the identified ideographic characters may be provided on a touch-sensitive monitor 45, and the user may touch the monitor 45 at a location where a desired ideographic character is displayed.

The combination of the first and second keypress may be a name identifying pinyin characters stored in the database 60, and these pinyin characters may be used to allow the user to identify a desired ideographic character. In such a system, the microprocessor 54 may provide pinyin characters that are associated with this name to a user for selection. For example, the identified pinyin characters may be provided on a touch-sensitive monitor 45, and the user may touch the monitor 45 at a location where a desired pinyin character is displayed. Upon selecting one of the pinyin characters, the microprocessor 54 receives the selection and then selects one or more ideographic characters that are associated with the selected pinyin characters in the database 60.

The microprocessor 54 may provide the pinyin characters in an order that assists the user with identifying a desired pinyin character from a list of pinyin characters that correspond to the name. For example, the pinyin characters may be provided to the user in an order representative of when each pinyin character was last selected. Alternatively, the pinyin characters may be presented in alphabetical order. A similar ordering of the ideographic characters displayed to the user may be made.

Another tactic may include predicting a pinyin character based on the pinyin characters that preceded. The predicted pinyin characters may be provided near the top of a list that is presented to the user. In this fashion, a user may be able to more easily identify and select the next desired pinyin character from the list. For example, if the user enters the pinyin “Zhong”, then the microprocessor 54 may be programmed to return and display on the monitor 45 a list of pinyin characters that are likely to be desired as the next pinyin character, in this instance two likely pinyin characters are “Wen” and “Guo”. In this situation, prediction of the next possible pinyin characters may be based on knowledge of likely phrases in the Chinese language. So in this example, “Wen” and “Guo” may be displayed near the top of a list in order to assist the user with selecting the next pinyin character.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of identifying an ideographic character, comprising:
providing a keypad having a plurality of keys, at least one of the keys representing more than one sound;
providing a database of characters, every character in the database being associated with one or more names, each name corresponding to exactly two keypresses;
assigning sounds to each of the keys, the assigned sounds comprising a first sound set;
pressing one of the keys corresponding to a desired first sound from the first sound set to both (A) provide a first keypress, and (B) initiate assigning sounds to each of the keys, the assigned sounds comprising a second sound set that is different from the first sound set;
pressing one of the keys corresponding to a desired second sound from the second sound set to provide a second keypress;
identifying one or more ideographic characters corresponding to both the first and second keypresses.

2. The method of claim 1, wherein the characters in the database are pinyin characters, and prior to identifying one or more ideographic characters, pinyin characters are provided to a user for selection, the provided pinyin characters being those that are associated with both the first and second keypresses, and the act of identifying one or more ideographic characters includes selecting one of the pinyin characters.

3. The method of claim 2, wherein the pinyin characters are provided to the user in an order representative of when each pinyin character was last selected.

4. The method of claim 2, further comprising predicting pinyin characters based on prior pinyin characters selected by the user, and providing the predicted pinyin characters to the user for selection.

5. The method of claim 1, further comprising providing the one or more ideographic characters to a user, and allowing the user to identify one of the provided ideographic characters.

6. The method of claim 1, wherein one of the sounds in the first sound set is silence.

7. The method of claim 1, wherein one of the sounds in the second set is silence.

8. The method of claim 1, wherein a sound in the first sound set is communicated to a user by displaying one or more characters phonetically representing the sound.

9. The method of claim 1, wherein a sound in the second sound set is communicated to a user by displaying one or more characters phonetically representing the sound.

10. A system for identifying an ideographic character, comprising:
a keypad having a plurality of keys, at least one of the keys representing more than one sound;
a database of characters, every character in the database being associated with one or more names, each name corresponding to exactly two keypresses;
a microprocessor programmed to (a) assign sounds to each of the keys, the assigned sounds comprising a first sound set, (b) receive an indication that one of the keys corresponding to a desired first sound from the first sound set has been pressed, and in response to both (i) receive a first keypress, and (ii) initiate assigning sounds to each of the keys, the assigned sounds comprising a second sound set that is different from the first sound set, (c) receive an indication that one of the keys corresponding to a desired second sound from the second sound set has been pressed to receive a second keypress, (d) identifying one or more ideographic characters corresponding to both the first and second keypresses.

11. The system of claim 10, wherein the characters in the database are pinyin characters, and prior to identifying one or more ideographic characters, the microprocessor provides pinyin characters to a user for selection, the provided pinyin characters being those that are associated with both the first and second keypresses, and the act of identifying one or more ideographic characters includes receiving a selection of one of the pinyin characters.

12. The system of claim 11, wherein the pinyin characters are provided to the user in an order representative of when each pinyin character was last selected.

13. The system of claim 11, wherein the microprocessor is further programmed to (i) predict pinyin characters based on prior pinyin characters selected by the user, and (ii) provide the predicted pinyin characters to the user for selection.

14. The system of claim 10, wherein the microprocessor is programmed to provide the one or more ideographic characters to a user, and allow the user to identify one of the provided ideographic characters.

15. The system of claim 10, wherein one of the sounds in the first sound set is silence.

16. The system of claim 10, wherein one of the sounds in the second set is silence.

17. The system of claim 10, wherein a sound in the first sound set is communicated to a user by displaying one or more characters phonetically representing the sound.

18. The system of claim 10, wherein a sound in the second sound set is communicated to a user by displaying one or more characters phonetically representing the sound.
